(19) United States
(12) Patent Application Publication
(10) Pub. No.: US 2022/0100193 A1
(43) Pub. Date: Mar. 31, 2022

(54) VEHICLE WHEELCHAIR LOADING SYSTEM

(71) Applicant: Ford Global Technologies, LLC, Dearborn, MI (US)

(72) Inventors: Stuart C Salter, White Lake, MI (US); Paul Kenneth Dellock, Northville, MI (US); Annette Lynn Huebner, White Lake, MI (US); Robin J. Stiyer, Grosse Pointe Farms, MI (US); Solomon Lin, Fort Wayne, IN (US)

(73) Assignee: Ford Global Technologies, LLC, Dearborn, MI (US)

(21) Appl. No.: 17/032,527

(22) Filed: Sep. 25, 2020

(51) Int. Cl. G05D 1/02; A61G 5/10; A61G 3/06; B60Q 1/24; B60Q 3/20; E05F 15/73; G06T 7/73

(52) U.S. Cl. CPC G05D 1/028; G06T 2207/30252; A61G 3/062; A61G 3/061; B60Q 1/24; B60Q 3/20; E05F 15/73; G06T 7/73; A61G 2203/22; A61G 2203/40; E05F 2015/767; E05Y 2400/454; E05Y 2400/44; E05Y 2900/531; G06T 2207/10024; A61G 5/1051

(57) ABSTRACT

A system includes a computer having a processor and a memory, and the memory storing instructions executable by the processor to cause the processor to determine that a wheelchair is located within a threshold distance of a vehicle; actuate a puddle lamp to project a light projection proximate to a door of the vehicle; determine whether the wheelchair is aligned with respect to the light projection based on an image captured by a camera, wherein the image includes image data comprising a position of the wheelchair relative to the light projection; and actuate the door of the vehicle to open in response to determining that a wheelchair user is located at a designated location relative to the vehicle.

### BACKGROUND

Accommodations for wheelchairs in vehicles are typically installed with modifications to a vehicle. The modifications may be a loading apparatus to carry and/or permit a wheelchair to enter the vehicle. Types of loading apparatuses include a deployable ramp, an elevatable platform, etc. The loading apparatus is typically installed behind a side door, such as a sliding door, or behind a rear lifting door of a van.

### BRIEF DESCRIPTION OF THE DRAWINGS

FIG. 1 is a perspective view of an example vehicle with doors closed and an example loading apparatus retracted.

FIG. 2 is a perspective view of the vehicle of FIG. 1 with one of the doors open and the loading apparatus extended.

FIG. 3 is a top view of the vehicle of FIG. 1 with a puddle lamp projecting a light projection.

FIG. 4 is a top view of the vehicle of FIG. 1 with the puddle lamp projecting the light projection and an accessible door of the vehicle is open.

FIG. 5 is a top view of the vehicle of FIG. 1 with a light projector projecting a light projection onto a floor portion of the vehicle.

FIG. 6 is a top view of the vehicle of FIG. 1 with the puddle lamp projecting another light projection based on up an obstruction relative to the vehicle.

FIG. 7 is a block diagram of an example control system for the vehicle of FIG. 1.

FIG. 8 is a process flow diagram of an example process for loading a user into the vehicle of FIG. 1.

### DETAILED DESCRIPTION

A system includes a computer having a processor and a memory, and the memory storing instructions executable by the processor to cause the processor to determine that a wheelchair is located within a threshold distance of a vehicle; actuate a puddle lamp to project a light projection proximate to a door of the vehicle; determine whether the wheelchair is aligned with respect to the light projection based on an image captured by a camera, wherein the image includes image data comprising a position of the wheelchair relative to the light projection; and actuate the door of the vehicle to open in response to determining that a wheelchair user is located at a designated location relative to the vehicle.

In other features, the processor is further programmed to: transmit one or more control signals to the wheelchair to cause the wheelchair to relocate with respect to the light projection.

In other features, the processor is further programmed to: transmit one or more control signals to the wheelchair to cause the wheelchair to enter the vehicle in response to determining that the wheelchair user is located at a designated location relative to the vehicle.

In other features, the processor is further programmed to: actuate a light projector to project a second light projection onto a floor portion of the vehicle; determine whether the wheelchair is aligned with respect to the second light projection based on an image captured by a second camera, wherein the image includes image data comprising a position of the wheelchair relative to the second light projection within the vehicle.

In other features, the processor is further programmed to: transmit one or more control signals to the wheelchair to cause the wheelchair to relocate within the vehicle with respect to the second light projection.

In other features, the processor is further programmed to: actuate one or more clamps to interface with the wheelchair.

In other features, the camera comprises a single lens camera.

In other features, the image data comprises pixel data representing the position of the wheelchair relative to the light projection.

In other features, the processor is further programmed to: actuate the puddle lamp to project a third light projection in response to determining that an obstruction is in a designated area relative to the vehicle.

A method can include determining, via a computer, that a wheelchair is located within a threshold distance of a vehicle; actuating a puddle lamp to project a light projection proximate to a door of the vehicle; determining whether the wheelchair is aligned with respect to the light projection based on an image captured by a camera, wherein the image includes image data comprising a position of the wheelchair relative to the light projection; and actuating the door of the vehicle to open in response to determining that a wheelchair user is located at a designated location relative to the vehicle.

In other features, the method includes transmitting one or more control signals to the wheelchair to cause the wheelchair to relocate with respect to the light projection.

In other features, the method includes transmitting one or more control signals to the wheelchair to cause the wheelchair to enter the vehicle in response to determining that the wheelchair user is located at a designated location relative to the vehicle.

In other features, the method includes actuating a light projector to project a second light projection onto a floor portion of the vehicle; and determining whether the wheelchair is aligned with respect to the second light projection based on an image captured by a second camera, wherein the image includes image data comprising a position of the wheelchair relative to the second light projection within the vehicle.

In other features, the method includes transmitting one or more control signals to the wheelchair to cause the wheelchair to relocate within the vehicle with respect to the second light projection.

In other features, the method includes actuating one or more clamps to interface with the wheelchair.

In other features, the camera comprises a single lens camera.

In other features, the image data comprises pixel data representing the position of the wheelchair relative to the light projection.

In other features, the image data comprises Red-Blue-Green pixel data.

In other features, the method includes actuating the puddle lamp to project a third light projection in response to determining that an obstruction is in a designated area relative to the vehicle.

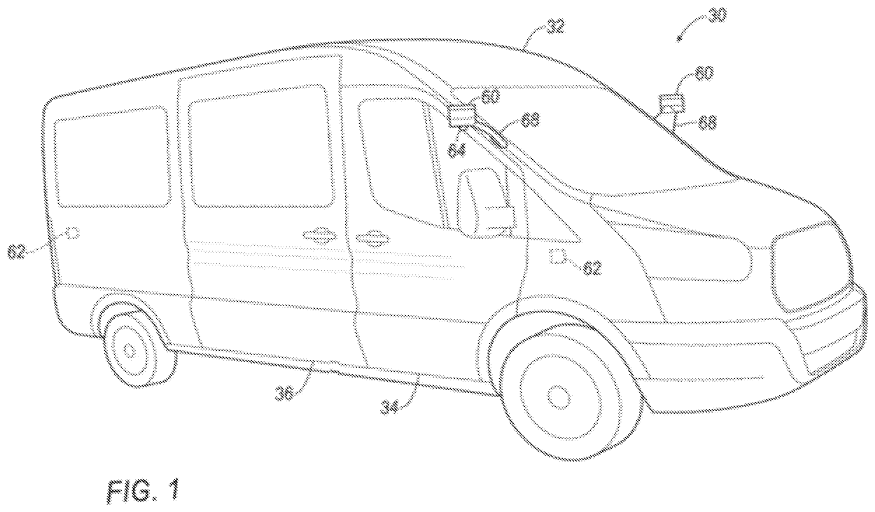

As illustrated in FIG. 1, a system 31 for a vehicle 30 includes a sensor 60 attachable to the vehicle 30 and a puddle lamp 64 fixed relative to the sensor 60 and oriented to project a light projection 70, 74, 80 downward beside the vehicle 30. A computer 54 may be in communication with the sensor 60 and the puddle lamp 64 and programmed to actuate the puddle lamp 64 in response to receiving data generated by the sensor 60 indicating a user located within a threshold distance of the vehicle 30.

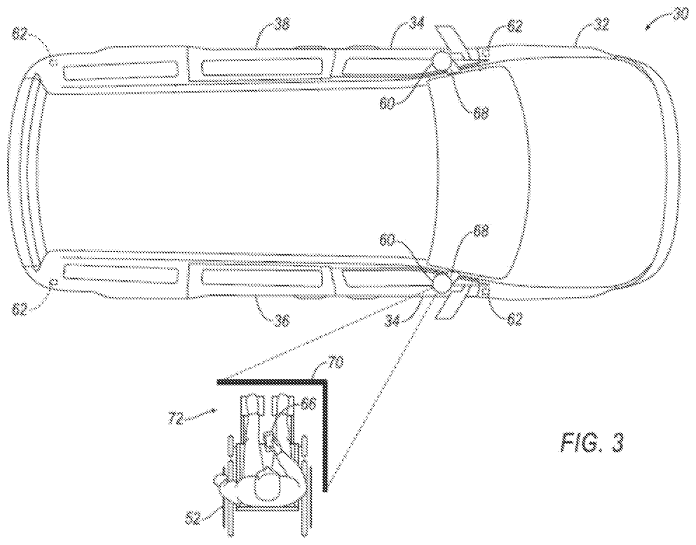

The system 31 provides an automated for a user in a wheelchair 52 to enter the vehicle 30. The sensor 60 and the puddle lamp 64 combine to actuate the puddle lamp 64 based on a location of the user and the steps performed to load the wheelchair 52 into the vehicle 30. The system 31 tracks the user and operates a loading apparatus 50, and illuminates the puddle lamp 64 based on the location of the user. The puddle lamp 64 can be actuated to illuminate to provide light projections 70, 74, 80 as seen in FIGS. 3-6 to communicate to the user concerning steps of a wheelchair-loading operation. Based on the illumination of the puddle lamp 64, the user may be able to enter the vehicle 30 with less assistance and greater independence.

With reference to FIG. 1, the vehicle 30 includes a body 32. The vehicle 30 may be of a unibody construction, in which a frame and the body 32 of the vehicle 30 are a single component, as shown in the Figures. The vehicle 30 may, alternatively, be of a body-on-frame construction, in which the frame supports the body 32 that is a separate component from the frame. The frame and body 32 may be formed of any suitable material, for example, steel, aluminum, etc.

The body 32 supports a plurality of doors 34, 36, 38. The doors 34, 36, 38 may be arranged on the sides and/or the rear of the vehicle 30 and may include front doors 34 and rear doors 36, 38. The doors 34, 36, 38, e.g., the rear doors 36, 38, may include at least one accessible door 36, behind which is the loading apparatus 50 for a wheelchair 52 (described below), and a nonaccessible door 38. The doors 34, 36, 38 may be conventional doors hinged at a front edge of the door that swing horizontally away from the body 32. Some of the doors 34, 36, 38 may be sliding doors that are mounted on and slide horizontally along a track next to the body 32 of the vehicle 30. The accessible door 36 is drivably movable relative to the body 32, such as by including an electric motor (not shown). More or fewer doors 34-38 than shown could be included in the vehicle 30.

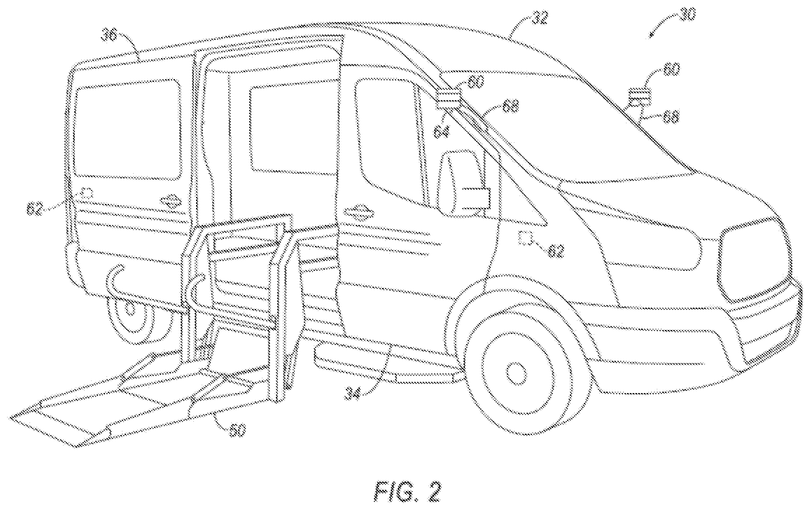

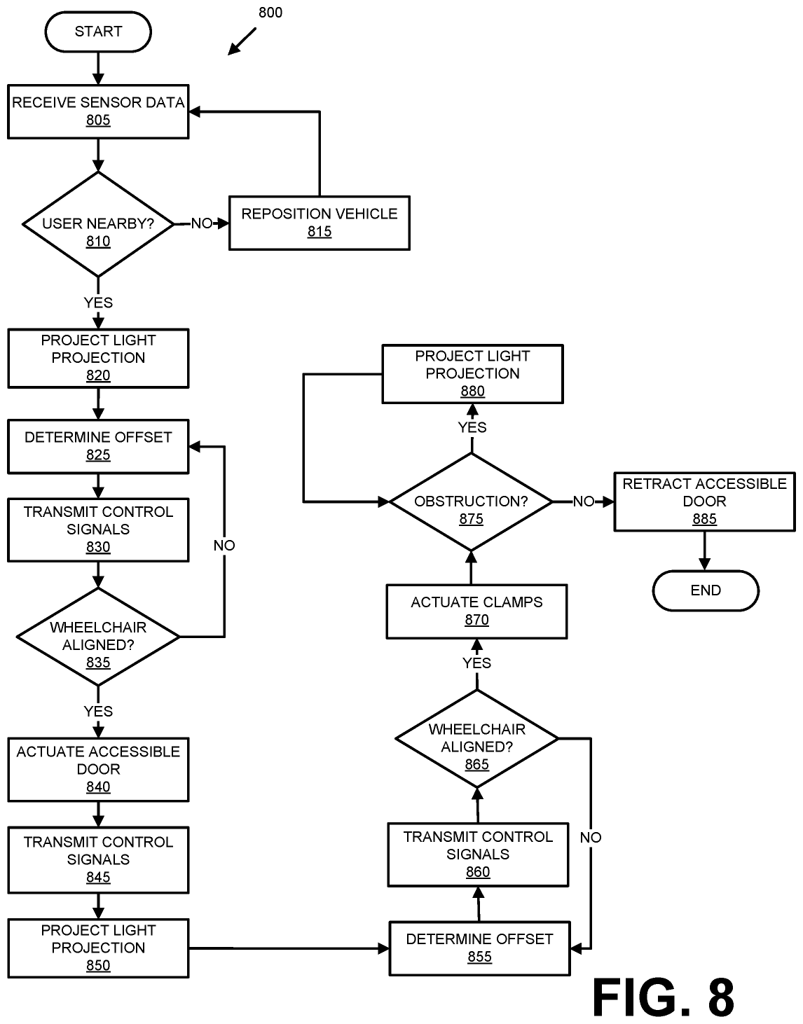

With reference to FIG. 2, the loading apparatus 50 may be fixed relative to the body 32 and disposed inside and adjacent to the accessible door 36. The loading apparatus 50 may be closer to the accessible door 36 than to any of the other doors 34, 38. The loading apparatus 50 may be any mechanism to carry and/or permit a wheelchair 52 to enter the vehicle 30. For example, the loading apparatus 50 may be a deployable ramp, an elevatable platform, etc., as are known. FIGS. 3 through 6 are described below with respect to FIG. 8.

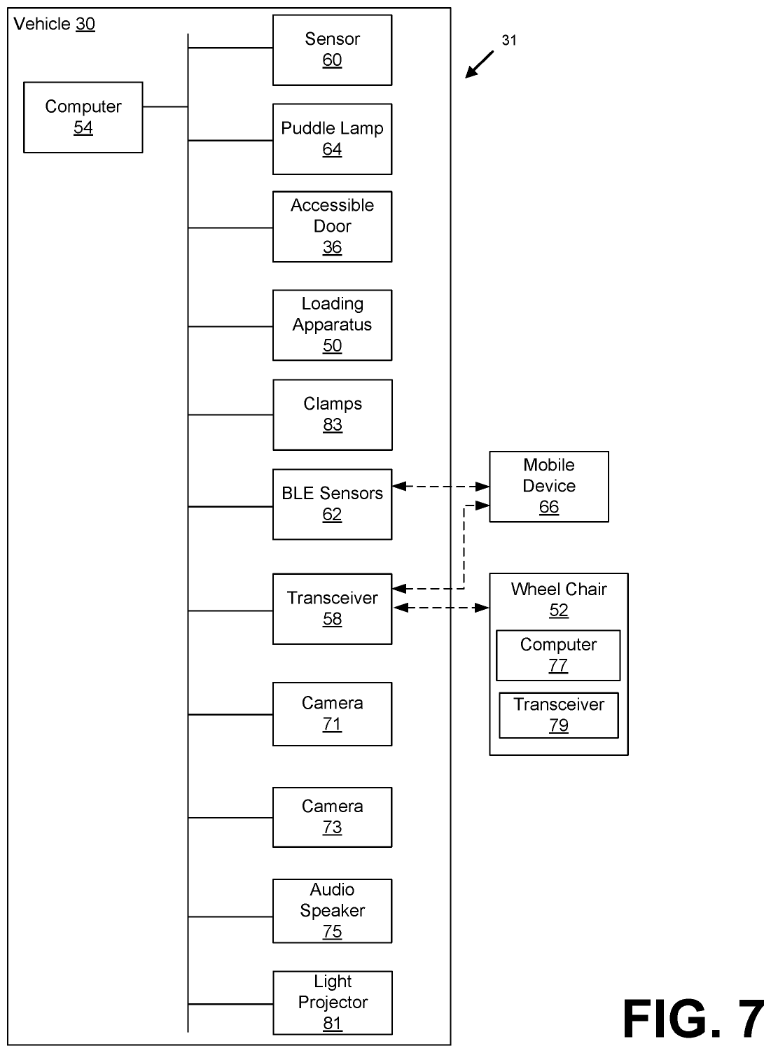

With reference to FIG. 7, the vehicle 30 includes the computer 54. The computer 54 is a microprocessor-based computer. The computer 54 includes a processor, memory, etc. The memory of the computer 54 includes memory for storing instructions executable by the processor as well as for electronically storing data and/or databases.

The computer 54 may transmit and receive data through a communications network 56 such as a controller area network (CAN) bus, Ethernet, WiFi, Local Interconnect Network (LIN), onboard diagnostics connector (OBD-II), and/or by any other wired or wireless communications network. The computer 54 may be in communication with the accessible door 36, the loading apparatus 50, a transceiver 58, the sensor 60, a plurality of Bluetooth Low Energy (BLE) sensors 62, a puddle lamp 64, a camera 71, a camera 73, an audio speaker 75, and other components via the communications network 56.

The transceiver 58 is connected to the communications network 56. The transceiver 58 may be adapted to transmit signals wirelessly through any suitable wireless communication protocol, such as Bluetooth®, WiFi, IEEE 802.11a/b/g, other RF (radio frequency) communications, etc. The transceiver 58 may be adapted to communicate with a remote server, that is, a server distinct and spaced from the vehicle 30. The remote server may be located outside the vehicle 30. For example, the remote server may be associated with other vehicles (e.g., V2V communications), infrastructure components (e.g., V2I communications via Dedicated Short-Range Communications (DSRC) or the like), emergency responders, a mobile device 66 associated with an owner or user of the vehicle 30, etc. The transceiver 58 may be one device or may include a separate transmitter and receiver.

The cameras 71, 73 can capture images representing an environment within a field-of-view (FOV) of the cameras 71, 73. The cameras 71, 73 can receive successive images, also referred to as “frames,” i.e., the cameras 71, 73 can be video cameras. Here, a “frame” or “image” comprises image data, e.g., pixel data. In an example implementation, the cameras 71, 73 can comprise any suitable red-blue-green (RGB) camera that captures two-dimensional (2D) image data. The camera 71 may be mounted to an exterior portion of the vehicle 30, e.g., secured to a pillar or a roof rail, and oriented such that the FOV of the camera 71 captures images proximate to the accessible door 36, and the camera 73 may be mounted to an interior portion of the vehicle 30, e.g., secured to a pillar or other structure, and oriented such that the FOV of the camera 73 captures images within an interior of the vehicle 30. In an example implementation, the cameras 71, 73 may comprise single lens cameras. The audio speaker 75 can be mounted to an exterior portion of the vehicle 30, e.g., a pillar, and produce audible signals, such as audible alerts, and oriented such that the audible signals are directed to area proximate to the accessible door 36.

The wheelchair 52 can include a computer 77 and a transceiver 79. The computer 77 is a microprocessor-based computer. The computer 77 includes a processor, memory, etc. The memory of the computer 77 includes memory for storing instructions executable by the processor as well as for electronically storing data and/or databases. The computer 77 can be programmed to, i.e., based on one or more instructions, can send control signals to one or more actuators within the wheelchair 52 to control operation of the wheelchair 52.

The transceiver 79 is adapted to transmit signals wirelessly through any suitable wireless communication protocol, such as Bluetooth®, WiFi, IEEE 802.11a/b/g, other RF (radio frequency) communications, etc. The transceiver 79 may be adapted to communicate with a remote server, that is, a server distinct and spaced from the wheelchair 52. The transceiver 79 may be one device or may include a separate transmitter and receiver.

With reference to FIG. 1, a sensor arm 68 is elongated from the body 32 and supports the sensor 60. The sensor 60 is attachable to the vehicle 30 via the sensor arm 68, which can be secured to a pillar or the like. Alternatively, the sensor arm 68 may be attached to a roof rail above the doors 34, 36, 38 or to any other position on the body 32 that does not move when the doors 34, 36, 38 open and close. The sensor arm 68 may have a tubular or other hollow shape, that is, a cavity may extend through the sensor arm 68. The cavity may allow wiring, tubes, etc. to pass through the sensor arm 68 while being shielded from the outside environment.

The sensor 60 may be designed to detect features of the outside world. For example, the sensor 60 may be a radar sensor, a scanning laser range finder, a light detection and ranging (LIDAR) device, or an image processing sensor such as a camera. In one example, the sensor 60 is a LIDAR device. A LIDAR device detects distances to objects by emitting laser pulses at a particular wavelength and measuring a time of flight for the pulse to travel to the object and back.

The vehicle 30 includes a plurality of the BLE sensors 62. Each BLE sensor 62 emits a signal that can be detected by the mobile device 66. The signal may include a location of the BLE sensor 62 relative to the body 32 of the vehicle 30. The mobile device 66 can approximate a distance to the BLE sensor 62 by measuring the signal strength of the signal from the BLE sensor 62. Using the locations of and the approximate distances to the BLE sensors 62, the mobile device 66 can determine its location relative to the vehicle 30 using conventional triangulation techniques, and the mobile device 66 can send that location to the computer 54 via the transceiver 58. The triangulation may be in two horizontal dimensions. Alternatively, the mobile device 66 can transmit the signal strengths or approximate distances to the BLE sensors 62 to the computer 54 via the transceiver 58, and the computer 54 can then triangulate the location of the mobile device 66 relative to the vehicle 30.

The BLE sensors 62 are fixed relative to the body 32 and spaced from each other horizontally relative to the body 32. The BLE sensors 62 are spaced sufficiently to provide different signal strengths from different BLE sensors 62 to the mobile device 66, which permits a more accurate triangulation.

The puddle lamp 64 is fixed relative to the body 32, and the puddle lamp 64 is fixed relative to the sensor 60. The puddle lamp 64 is attached directly or indirectly to the body 32. For example, the puddle lamp 64 may be attached to the sensor 60, and the puddle lamp 64 may be disposed underneath the sensor 60, i.e., on a surface of the sensor 60 facing downward relative to the body 32. The puddle lamp 64 is spaced from the doors 34, 36, 38 and remains in a fixed location relative to the body 32 when the doors 34, 36, 38 move.

A “puddle lamp,” for the purposes of this disclosure, is a lamp oriented to illuminate the ground beside the vehicle 30. The puddle lamp 64 may be any lighting system suitable for illuminating a roadway beside the vehicle 30, including tungsten, halogen, high-intensity discharge (HID) such as xenon, light-emitting diode (LED), laser, etc. The puddle lamp 64 can switch between projecting light projections 70, 74, 80 of different shapes and/or different colors of light on the ground. For example, the puddle lamp 64 may include a plurality of bulbs, and illuminating different arrangements of the bulbs results in light projections 70, 74, 80 of different shapes projected by the puddle lamp 64 on the ground. For another example, the puddle lamp 64 may include a plurality of stencils, and shining light through respective stencils projects light projections 70, 74, 80 of different shapes on the ground. For another example, the puddle lamp 64 may include a single stencil and multiple bulbs of different colors behind the stencil, and illuminating different bulbs can project light projections 70, 74, 80 of the same shape in different colors on the ground.

The puddle lamp 64 is oriented to project a light projection 70, 74, 80 downward beside the vehicle 30. For example, the puddle lamp 64 may be located and oriented to project a light projection 70, 74, 80 beside the accessible door 36. The puddle lamp 64 may be located to project a light projection 70, 74, 80 on the ground regardless of whether the accessible door 36 is open or closed.

FIG. 8 is a process flow diagram illustrating an example process 800 for loading a user into the vehicle 30. The memory of the computer 54 typically stores executable instructions for performing the steps of the process 800.

The process 800 begins in a block 805, in which the computer 54 receives data generated by the sensor 60 and/or the BLE sensors 62. The data permits the computer 54 to determine a two-dimensional location of a user, i.e., in a horizontal plane or according to horizontal coordinates specifying a location on a ground surface. For example, the computer 54 may receive data from the sensor 60 and perform a conventional object-recognition algorithm on the data to recognize an object, e.g., a user in a wheelchair 52, as well as a distance from the sensor 60 to the object, e.g., wheelchair 52. Data representing users in wheelchairs in various orientations may be stored in the memory of the computer 54 as baseline data for the computer 54 to compare to the data received from the sensor 60. For another example, the computer 54 may receive the position of the mobile device 66 of the user from the mobile device 66 via the transceiver 58, which the mobile device 66 determined using the signals from the BLE sensors 62, as described above. For another example, the computer 54 may receive the signal strengths or approximate distances to each of the BLE sensors 62 from the mobile device 66 via the transceiver 58, as described above.

Next, in block 810, the computer 54 determines whether the data generated by the sensor 60 or the BLE sensors 62 indicates that the user is located within a threshold distance from the vehicle 30. The threshold distance can be selected such that the ramp does not hit the user or the wheelchair 52 when the ramp is extended by the loading apparatus 50. If a user is not within the threshold distance, the computer 54 operates the vehicle 30 to relocate the vehicle 30, i.e., change a location of the vehicle 30, relative to the user at block 815. After the vehicle 30 is relocated, the process 800 returns to the block 805.

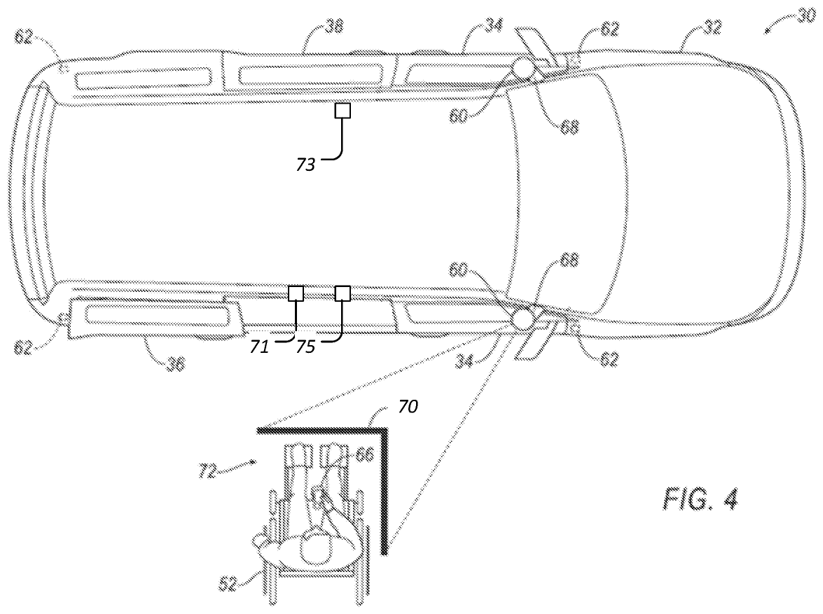

If a user is within the threshold distance, in block 820, the computer 54 actuates the puddle lamp 64 to project a light projection 70 proximate to the vehicle 30. For example, the computer 54 can actuate the puddle lamp 64 to project a light projection 70 on the ground adjacent to the accessible door 36 as shown in FIG. 3. In some example implementations, a suspension of the vehicle may be modified to lower the vehicle 30 once the vehicle 30 is stationary. The light projection 70 can be used by the computer 54 to align the wheelchair 52 with the ramp. For example, as shown in FIGS. 3 and 4, the light projection 70 may be two lines forming a right angle. At block 825, the computer 54 determines an offset of the wheelchair 52 with respect to the light projection 70. The computer 54 can receive images, such as RGB, images from the camera that include the light projection 70 and the wheelchair 52. A computer 54 can calculate a horizontal and/or vertical offset between the wheelchair 52 and the light projection 70 based on the images received from the camera 71. In an example implementation, the computer 54 calculates the horizontal offsets and/or vertical offsets using known triangle similarity techniques that determine a distance between one or more lines of the light projection 70 and a position of the wheelchair 52. For example, the computer 54 can use calculate the distance a distance between one or more lines of the light projection and a position of the wheelchair 52 via Equation 1:

D=(W*F)/P Equation 1,

where D represents the calculated distance between one or more lines of the light projection 70, W represents a width of one or more lines of the light projection 70, F represents a focal length of the camera 71, and P represents a perceived pixel width of one or more lines of the light projection 70

The computer 54 can determine an amount of pixels between the one of the lines of the light projection 70 and the wheelchair 52. For example, using the calculated distance is determined via Equation 1, the computer 54 determines an amount of pixels between one of the lines of the light projection 70 and the wheelchair 52. Based on the determined amount of pixels, the computer 54 calculates the horizontal offsets and/or vertical offsets with respect to the light projection 70. For example, the computer 54 can include a lookup table or the like that relates a determined amount of pixels to horizontal offsets and/or vertical offsets that represent the distance between the lines of the light projection 70 and the wheelchair 52.

At block 830, the computer 54 transmits control signals to the wheelchair 52 based on the determined offsets. That is, the computer 54 can transmit control signals to the wheelchair 52 such that the computer 77 of the wheelchair 52 causes the wheelchair 52 to relocate itself with respect to the light projection 70. For instance, the computer 77 of the wheelchair 52 can actuate one or more components of the wheelchair 52 so that the wheelchair 52 can relocate itself based on the offsets. The control signals can indicate a horizontal distance and/or vertical distance the wheelchair 52 should move to align itself relative to the light projection 70. The computer 54 can also send alert signals to the audio speaker 75 that can generate an audible alert to the user that the user is informed of the wheelchair 52 realignment. Additionally or alternatively, the computer 54 can send alert signals to the mobile device 66 of the user.

At block 835, the computer 54 determines whether the wheelchair 52 is aligned relative to the light projection 70. The computer 54 can determine the wheelchair 52 is aligned, or at a designated location relative to the vehicle 30, when the wheelchair 52 is within a predetermined threshold of the light projection 70 as shown in FIG. 4. For example, the predetermined threshold may be defined as when at least a portion of the user or the wheelchair 52 intersects with the light projection 70. If the wheelchair 52 is not aligned with the light projection 70, the process 800 returns to block 825.

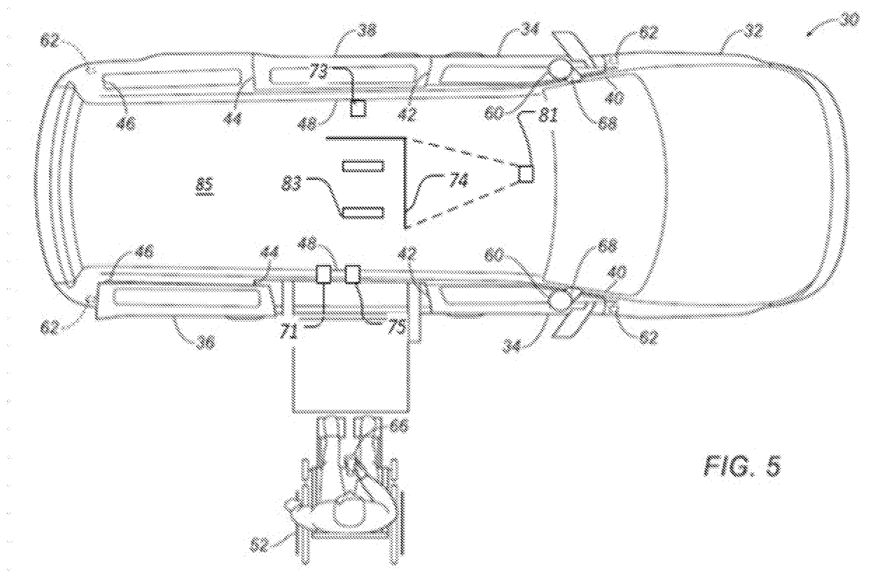

At block 840, the computer 54 actuates the accessible door 36 of the vehicle 30 to open. In block 840, the computer 54 actuates the loading apparatus 50 to deploy. For example, the loading apparatus 50 may extend a ramp of the loading apparatus 50 outward or may rotate a platform of the loading apparatus 50 flat and lower the platform to the ground as shown in FIG. 5.

At block 845, the computer 54 sends control signals to the wheelchair 52 to cause the wheelchair 52 to enter the vehicle 30 via the extended ramp. The control signals can indicate a distance to travel from an initial position of the wheelchair 52 to a destination position within the vehicle 30. The computer 54 can also triangulate the location of the mobile device 66 relative to the vehicle 30 as the wheelchair 52 enters the vehicle 30 using BLE signals via the techniques described above.

At block 850, the computer 54 actuates the light projector to project a light projection 74 onto a floor portion 85 of the vehicle 30. The light projection 74 may be two lines forming a right angle. The light projection 74 can be used by the computer 54 to align the wheelchair 52 within the interior of the vehicle 30.

At block 855 the computer 54 determines an offset of the wheelchair 52 with respect to the light projection 74. The computer 54 can receive images, such as RGB pixel images, images from the camera 73 that include the light projection 74 and the wheelchair 52. The computer 54 can calculate a horizontal and/or vertical offset between the wheelchair 52 and the light projection 74 based on the images received from the camera 73 similar to the techniques described above with respect to light projection 70. At block 860, the computer 54 transmits control signals to the wheelchair 52 based on the determined offsets. The computer 54 can transmit control signals to the wheelchair 52 such that the computer 77 of the wheelchair 52 causes the wheelchair 52 to relocate itself with respect to the light projection 74.

At block 865, the computer 54 determines whether the wheelchair 52 is aligned relative to the light projection 74. In an example implementation, the computer 54 can determine the wheelchair 52 is aligned when the wheelchair 52 interfaces or overlaps one or more portions of the light projection 74. The computer 54 can determine whether the wheelchair 52 is aligned based on the image data received from the camera 73. In one example, the wheelchair 52 can be determined to be aligned with the light projection 74 if at least a portion of wheelchair 52 interfaces or overlaps with the lines of the light projection 74. For example, the wheelchair 52 can be aligned if at least one pixel representing the wheelchair 52 overlaps with at least one pixel representing one of the lines of the light projection 74. If the wheelchair 52 is not aligned, the process 800 returns to block 865.

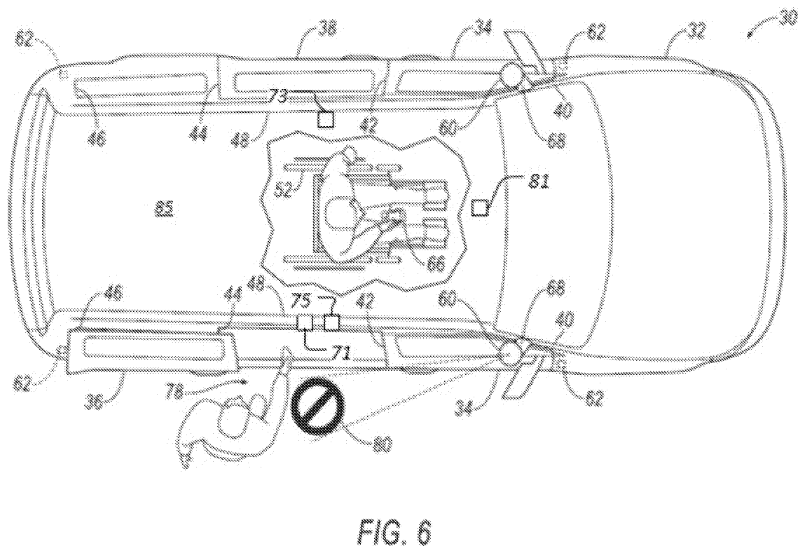

At block 870, the computer 54 actuates one or more clamps 83 to interface with the wheelchair 52. The clamps 83 can prevent movement of the wheelchair 52 while the vehicle 52 is in transit as shown in FIG. 6. In block 875, the computer 54 determines from the data received from the sensor 60 whether an obstruction is in a designated area 78 relative to the vehicle 30. The designated area 78 may be chosen as an area in which an object may interfere with closing the door or retracting the loading apparatus 50. For example, the computer 54 may receive data from the sensor 60 and perform a known object-detection algorithm on the data to detect any objects within the designated area 78. If no obstruction is in the designated area 78, the process 800 proceeds to a block 890.

If an obstruction is in the designated area 78 the computer 54 actuates the puddle lamp 64 to project a light projection 80 on the ground in front of the accessible door 36 at block 885. The light projection 80 may be chosen to communicate to the user or to another nearby person (who may be the obstruction) to avoid the designated area 78. For example, as shown in FIG. 6, the light projection 80 may be a circle-backslash symbol, instructing the user or other people to avoid the designated area 78. The process 800 can return to block 875.

If no obstruction is in the designated area 78, the computer 54 actuates the loading apparatus 50 to retract at block 890. In block 895, the computer 54 actuates the accessible door 36 of the vehicle 30 to close, and the process 800 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising a computer including a processor and a memory, the memory storing instructions executable by the processor to cause the processor to:
determine that a wheelchair is located within a threshold distance of a vehicle;
actuate a puddle lamp to project a light projection proximate to a door of the vehicle;
determine whether the wheelchair is aligned with respect to the light projection based on an image captured by a camera, wherein the image indicates a location of the wheelchair relative to the light projection; and
actuate the door of the vehicle to open in response to determining that a wheelchair user is located at a designated location relative to the vehicle.

2. The system of claim 1, wherein the processor is further programmed to: transmit one or more control signals to the wheelchair to cause the wheelchair to relocate with respect to the light projection.

3. The system of claim 1, wherein the processor is further programmed to: transmit one or more control signals to the wheelchair to cause the wheelchair to enter the vehicle in response to determining that the wheelchair user is located at a designated location relative to the vehicle.

4. The system of claim 3, wherein the processor is further programmed to: actuate a light projector to project a second light projection onto a floor portion of the vehicle; determine whether the wheelchair is aligned with respect to the second light projection based on an image captured by a second camera, wherein the image includes image data comprising a position of the wheelchair relative to the second light projection within the vehicle.

5. The system of claim 4, wherein the processor is further programmed to: transmit one or more control signals to the wheelchair to cause the wheelchair to relocate within the vehicle with respect to the second light projection.

6. The system of claim 5, wherein the processor is further programmed to: actuate one or more clamps to interface with the wheelchair.

7. The system of claim 4, wherein the image data comprises pixel data representing the position of the wheelchair relative to the light projection.

8. The system of claim 8, wherein the image data comprises Red-Blue-Green pixel data.

9. The system of claim 1, wherein the camera comprises a single lens camera.

10. The system of claim 1, wherein the processor is further programmed to: actuate the puddle lamp to project a third light projection in response to determining that an obstruction is in a designated area relative to the vehicle.

11. A method comprising:
determining, via a computer, that a wheelchair is located within a threshold distance of a vehicle;
actuating a puddle lamp to project a light projection proximate to a door of the vehicle;
determining whether the wheelchair is aligned with respect to the light projection based on an image captured by a camera, wherein the image includes image data comprising a position of the wheelchair relative to the light projection; and
actuating the door of the vehicle to open in response to determining that a wheelchair user is located at a designated location relative to the vehicle.

12. The method of claim 11, further comprising: transmitting one or more control signals to the wheelchair to cause the wheelchair to relocate with respect to the light projection.

13. The method of claim 11, further comprising: transmitting one or more control signals to the wheelchair to cause the wheelchair to enter the vehicle in response to determining that the wheelchair user is located at a designated location relative to the vehicle.

14. The method of claim 13, further comprising: actuating a light projector to project a second light projection onto a floor portion of the vehicle; and determining whether the wheelchair is aligned with respect to the second light projection based on an image captured by a second camera, wherein the image includes image data comprising a position of the wheelchair relative to the second light projection within the vehicle.

15. The method of claim 14, further comprising: transmitting one or more control signals to the wheelchair to cause the wheelchair to relocate within the vehicle with respect to the second light projection.

16. The method of claim 15, further comprising: actuating one or more clamps to interface with the wheelchair.

17. The method of claim 14, wherein the image data comprises pixel data representing the position of the wheelchair relative to the light projection.

18. The method of claim 18, wherein the image data comprises Red-Blue-Green pixel data.

19. The method of claim 11, wherein the camera comprises a single lens camera.

20. The method of claim 11, the method further comprising: actuating the puddle lamp to project a third light projection in response to determining that an obstruction is in a designated area relative to the vehicle.
